(19) United States
(12) Patent Application Publication
(10) Pub. No.: US 2003/0162142 A1
(43) Pub. Date: Aug. 28, 2003

(54) Reusable tapered candle and candle-making method

(76) Inventors: Gloria Bennetts, Lake Forest, CA (US); Kenneth L. Simonson, Lake Forest, CA (US)

Correspondence Address: Kenneth W. Float, The Law Offices of Kenneth W. Float, P. O. Box 80790, Rancho Santa Margarita, CA, 92688, US

(21) Appl. No.: 10/084,693

(22) Filed: Feb. 27, 2002

(51) Int. Cl. C11C 5/00

(52) U.S. Cl. 431/291; 431/288; 264/36.15

(57) ABSTRACT

An exemplary candle comprises an outer tapered shell with a plurality of tapered sidewalls that are joined together at abutting edges. The shell comprises a material that does not completely melt when the candle is burned. A wick disposed within the shell, and paraffin is disposed the tapered shell to cover the wick except near the top of the candle where the wick is exposed, that is designed to melt when the candle is burned. The paraffin may comprise paraffin beads that partially fill the shell and cover the wick. An exemplary method includes providing a candle that has an outer shell made of a material that does not completely melt when the candle is burned, disposing a wick in the outer shell, and filling the outer shell with paraffin beads to surround the wick to a desired level that keeps an upper end of the wick exposed.

### BACKGROUND

The present invention relates generally to candles, and more particularly, to a reusable tapered candle and method of constructing a candle.

Candles have been used for centuries for many lighting purposes. Tapered candle having a round cross section have been used in churches, and the like, and are typically inserted into candle holders near alters, for example. However, heretofore no tapered candles have been developed that have a square or rectangular cross section.

In the past, candles have been refilled with paraffin. A wick is placed in the open cavity of the melted candle that remains after the candle has been burned, and paraffin (candle wax) is liquefied (melted) and poured into the cavity to fill it up to cover the wick.

However, heretofore, no candle has been developed that employs a replacement wick that is placed into a shell and that does not require the use of melted paraffin to be poured into the shell to surround the wick and thereby provide a reusable candle. It is therefore an objective of the present invention to provide for a reusable tapered candle and method of constructing a candle.

### SUMMARY OF THE INVENTION

To accomplish the above and other objectives, the present invention provides for a reusable (preferably tapered) candle and method of construction. The tapered candle has a square or rectangular cross section. The tapered candle has an outer shell that comprises four trapezoidally-shaped sidewalls that have chamfered abutting edges that are joined at the abutting edges. The sidewalls are tapered from a larger end at the top to a smaller end at the bottom.

The sidewalls comprise paraffin and additional additives that prevent the sidewalls from completely melting when the candle burns. The additives include a hardener and coloring.

The joined sidewalls (or shell) form a tapered vase-like vessel into which a wick is placed near the longitudinal centerline thereof. Paraffin, or candle wax, that is designed to melt when the candle is burned, is poured into the tapered vase-like vessel or shell to cover the wick except near the top of the candle where the wick is exposed. The paraffin disposed in the tapered vase-like vessel or shell is preferably disposed to a level below the top of the candle.

Outer surfaces of the sidewalls of the tapered vase-like vessel may be adorned with ornaments, such as silk flowers, various fruits, or other objects affixed thereto. The paraffin, or candle wax, may be scented with selected oils that correspond to the scent emanating from the ornament on the outer surfaces of the sidewalls.

The candle is reusable after the paraffin has been melted and the original wick has burned away. Since the shell is designed not to burn while the candle is lit and burned, the shell is reusable. A replacement wick having a metal base to support it is inserted into the shell so that it projects vertically towards the top of the candle.

Colored paraffin beads, similar to small ball bearings, are poured into the shell around the replacement wick until they fill the shell to a desired height that exposes the replacement wick. The colored paraffin beads are pressed downward to compact them around the replacement wick. The colored paraffin beads may be scented with various selected oils to provide flower scents, and the like, when the reconstructed candle is lit and the paraffin beads melt.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 illustrates an exemplary reusable tapered candle in accordance with the principles of the present invention;

FIG. 2 illustrates the reusable tapered candle shown in FIG. 1 having exemplary ornaments disposed on outer surfaces thereof;

FIG. 3 is a top view of the exemplary candle shown in FIG. 1;

FIG. 4 is a side view of the exemplary candle shown in FIG. 1;

FIG. 5 is a cross sectional side view of the exemplary candle shown in FIG. 1;

FIG. 6 is a bottom view of the exemplary candle shown in FIG. 1; and

FIG. 7 is a flow diagram that illustrates an exemplary method in accordance with the principles of the present invention.

### DETAILED DESCRIPTION

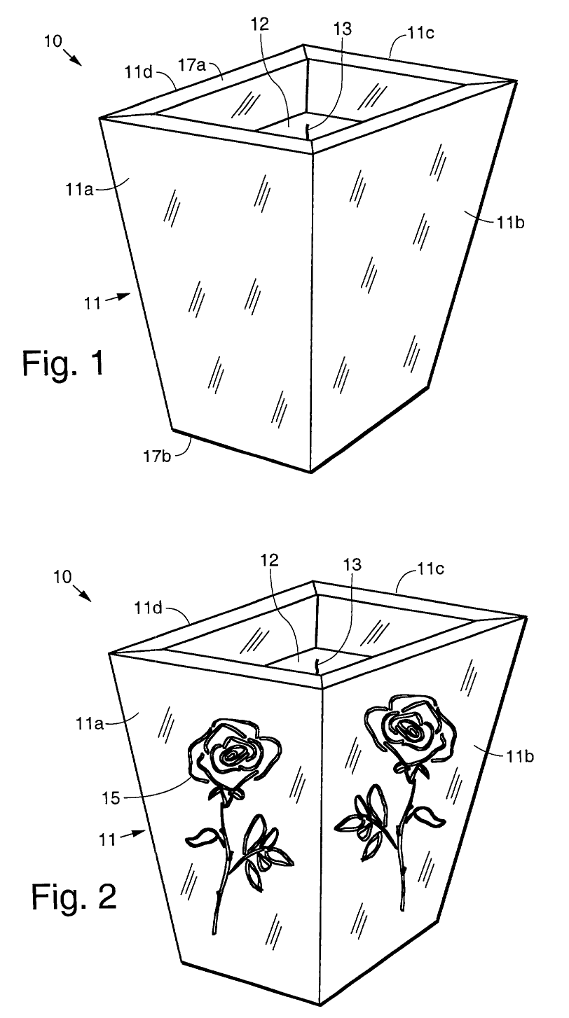

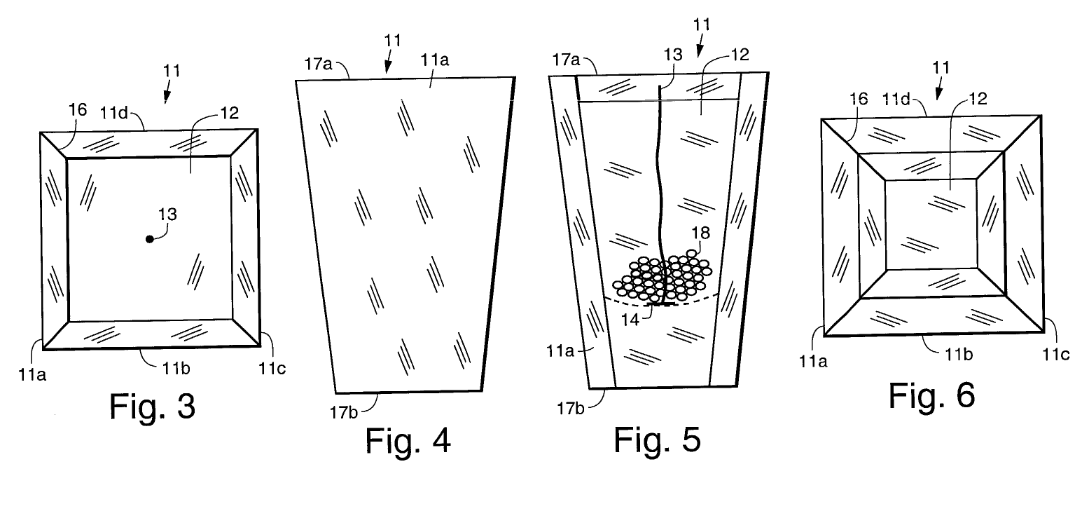

Referring to the drawing figures, FIG. 1 illustrates an exemplary reusable tapered candle 10 in accordance with the principles of the present invention. FIGS. 3-6 illustrate top, side, cross sectional, and bottom views, respectively, of the exemplary candle 10 shown in FIG. 1;

The reusable tapered candle has an outer shell 11 that comprises four tapered, trapezoidally-shaped, sidewalls 11a, 11b, 11c, 11d that have chamfered abutting edges 16 and are joined at the abutting edges 16. The sidewalls 11a, 11b, 11c, 11d are joined in a manner similar to that of a picture frame, for example. The sidewalls 11a, 11b, 11c, 11d are preferably tapered from a larger upper end 17a at the top of the candle 10 to a smaller lower end 17b at the bottom of the candle 10. The reusable tapered candle 10 preferably has a square or rectangular cross section and has a vase-like structure.

The sidewalls 11a, 11b, 11c, 11d comprise paraffin and additional additives that prevent the sidewalls 11a, 11b, 11c, 11d from completely melting when the candle 10 burns. The additives include a hardener such as Vybar®, for example, available from Petrolite Corporation, and coloring.

The sidewalls 11a, 11b, 11c, 11d, when joined, form a tapered vase-like vessel 11 (or shell 11) into which a wick 13 is placed near the longitudinal centerline thereof. Paraffin 12, or candle wax 12, that is designed to melt when the candle 10 is burned, is poured into the tapered vase-like vessel 11 or shell 11 to cover the wick 13 except near the top of the candle 10 where the wick is exposed. The paraffin 12 disposed in the tapered vase-like vessel 11 or shell 11 is preferably disposed to a level below the upper end 17a of the candle 10.

FIG. 2 illustrates the reusable tapered candle 10 with exemplary ornaments 15 disposed on outer surfaces thereof. The outer surfaces of the sidewalls 11a, 11b, 11c, 11d of the tapered vase-like vessel 11 may be adorned with ornaments 15, such as silk flowers, various fruit like objects, or other objects affixed thereto. The paraffin 12, or candle wax 12, may be scented with selected oils that correspond to the scent emanating from the ornament 15 on the outer surfaces of the sidewalls 11a, 11b, 11c, 11d.

The candle 10 is reusable after the paraffin 12 has been melted and the original wick 13 has burned away. Since the shell 11 is designed not to burn while the candle 10 is lit and burned, the shell 11 is reusable. When the candle 10 bums down, it produces a bowl at the bottom of the vessel 11 or shell 11 (illustrated by the dashed line in FIG. 5),

A refill kit is preferably provided that contains one or more replacement wicks 13 and a package of scented, colored beads 18 for use in replacing the wax 12 that was lost when the candle 10 was burned. A replacement wick 13 having a metal base 14 (FIG. 5) to support it is placed in the shell 11 so that it projects vertically towards the top of the candle 10.

Colored paraffin beads 18 (some of which are shown in FIG. 5), similar to small ball bearings, are poured into the shell 11 around the replacement wick 13 until they fill the shell 11 to a desired height that exposes the replacement wick 13. The colored paraffin beads 18 are pressed downward to compact them around the replacement wick 13. The colored paraffin beads 18 may be scented with selected oils to provide flower scents, and the like, when the reconstructed candle is lit and the paraffin beads 18 melt.

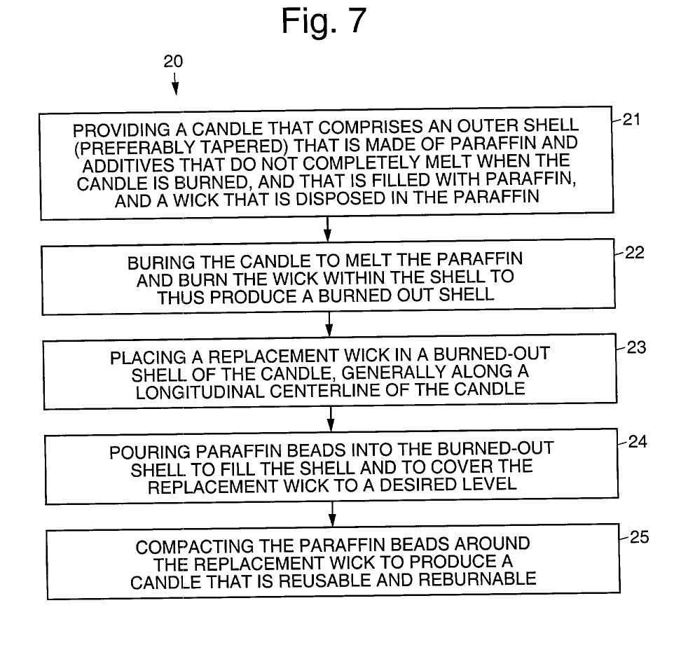

FIG. 7 is a flow diagram that illustrates an exemplary method 20 in accordance with the principles of the present invention. The exemplary method 20 comprises the following steps.

A candle 10 is provided 21 that comprises an outer shell 11 (preferably tapered) that is made of paraffin and additives that do not completely melt when the candle 10 is burned, and that is filled with paraffin 12, and a wick 13 that is disposed in the paraffin 12. After the candle 10 is burned 22 to melt the paraffin 12 and burn the wick 13 within the shell 11, a replacement wick 13 is placed 23 in the burned-out shell 11, generally along a longitudinal centerline of the candle. Paraffin beads 18 are poured 24 into the burned-out shell 11 to fill the shell 11 and to cover the replacement wick 13 to a desired level. The paraffin beads 18 are then compacted 25 around the replacement wick 13. The candle 10 is thus rendered reusable and may be burned.

Thus, a reusable tapered candle and method of constructing a candle have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A candle comprising:
an outer tapered shell comprising a plurality of tapered sidewalls that are joined together at abutting edges which shell comprises a material that does not completely melt when the candle is burned;
a wick disposed within the shell; and
paraffin disposed the tapered shell to cover the wick except near the top of the candle where the wick is exposed, that is designed to melt when the candle is burned.

2. The candle 10 recited in claim 1 wherein the tapered sidewalls are trapezoidally-shaped.

3. The candle 10 recited in claim 1 wherein the tapered sidewalls have chamfered abutting edges that are joined together.

4. The candle 10 recited in claim 1 wherein the sidewalls are tapered from a larger upper end at the top of the candle to a smaller lower end at the bottom of the candle.

5. The candle 10 recited in claim 1 wherein the candle has a square cross section.

6. The candle 10 recited in claim 1 wherein the candle has a rectangular cross section.

7. The candle 10 recited in claim 1 wherein the sidewalls comprise paraffin and additional additives that prevent them from completely melting when the candle burns.

8. The candle 10 recited in claim 1 wherein the paraffin disposed the tapered shell comprises paraffin beads that at least partially fill the shell and cover the wick.

9. A method comprising:
providing a candle that comprises an outer shell made of a material that does not completely melt when the candle is burned;
disposing a wick in the outer shell; and
filling the outer shell with paraffin beads to surround the wick to a desired level that keeps an upper end of the wick exposed.

10. The method recited in claim 9 wherein the outer shell is tapered.

11. The method recited in claim 9 wherein the outer shell comprises a plurality of tapered sidewalls that are joined together at abutting edges.

12. The method recited in claim 11 wherein the tapered sidewalls are trapezoidally-shaped.

13. The method recited in claim 11 wherein the tapered sidewalls have chamfered abutting edges that are joined together.

14. The method recited in claim 11 wherein the sidewalls are tapered from a larger upper end at the top of the candle to a smaller lower end at the bottom of the candle.

15. The method recited in claim 9 wherein the candle has a square cross section.

16. The method recited in claim 9 wherein the candle has a rectangular cross section.
